(19) United States
(12) Patent Application Publication
(10) Pub. No.: US 2024/0402422 A1
(43) Pub. Date: Dec. 5, 2024

(54) OPTICAL WAVEGUIDE DEVICE

(71) Applicant: SHINKO ELECTRIC INDUSTRIES CO., LTD., Nagano (JP)

(72) Inventors: Hisashi KANEDA, Nagano (JP); Takuya HORIUCHI, Tokyo (JP)

(21) Appl. No.: 18/679,768

(22) Filed: May 31, 2024

(30) Foreign Application Priority Data
Jun. 5, 2023 (JP) 2023-092649

(51) Int. Cl. G02B 6/122; G02B 6/12

(52) U.S. Cl. CPC G02B 6/122; G02B 2006/12061

(57) ABSTRACT

An optical waveguide device includes a first cladding layer, a core layer disposed on the first cladding layer and forming cores, and a second cladding layer disposed on the first cladding layer and selectively covering the core layer, wherein a first region not covered by the second cladding layer is provided on the first cladding layer, wherein the cores include signal cores, one end of which is disposed in the first region, for inputting or outputting signal light, and an inspection core, both ends of which are exposed at an outer perimeter surface of the optical waveguide device, for inputting or outputting inspection light, and wherein the inspection core is made of a same material as the signal cores, and a cross-sectional shape of the inspection core in a short-hand direction is identical to a cross-sectional shape of each of the signal cores in a short-hand direction.

### CROSS-REFERENCE TO RELATED APPLICATIONS

The present application is based on and claims priority to Japanese Patent Application No. 2023-092649 filed on Jun. 5, 2023, with the Japanese Patent Office, the entire contents of which are incorporated herein by reference.

### FIELD

The disclosures herein relate to optical waveguide devices.

### BACKGROUND

An optical waveguide device as known in the art has an optical waveguide including a core layer and cladding layers. Such an optical waveguide device has a silicon photonic chip mounted thereon and optically coupled with the optical waveguide, and is used in a data center or the like where various equipment such as computers and data communication apparatuses are installed.

For the optical waveguide device as described above, it may sometimes be difficult to nondestructively inspect the optical waveguide when no silicon photonic chip is mounted. In the case in which the optical waveguide can be inspected only after the mounting of a silicon photonic chip, the defect of the optical waveguide cannot be detected sufficiently early. In such a case, the optical waveguide device obtained by mounting a silicon photonic chip may turn out to be defective, which leads to a decrease in the yield.

There may be a need for an optical waveguide device which allows the optical waveguide to be inspected before mounting a silicon photonic chip.

### Related-Art Documents

### Patent Documents

[Patent Document 1] Japanese Laid-open Patent Publication No. 2011-237504

### SUMMARY

According to an aspect of the embodiment, an optical waveguide device includes a first cladding layer, a core layer disposed on the first cladding layer and forming a plurality of cores, and a second cladding layer disposed on the first cladding layer and selectively covering the core layer, wherein a first region not covered by the second cladding layer is provided on the first cladding layer, wherein the plurality of cores include a plurality of signal cores, a first end of which is disposed in the first region, for inputting or outputting signal light, and an inspection core, a first end and a second end of which are exposed at an outer perimeter surface of the optical waveguide device, for inputting or outputting inspection light, and wherein the inspection core is made of a same material as the signal cores, and a cross-sectional shape of the inspection core in a short-hand direction thereof is identical to a cross-sectional shape of each of the signal cores in a short-hand direction thereof.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A through 1C are drawings illustrating an optical waveguide device according to a first embodiment;

FIG. 2 is a schematic drawing illustrating a method of inspecting an inspection core group;

FIG. 3 is a plan view illustrating an optical waveguide device according to a first variation of the first embodiment;

FIG. 4 is a plan view illustrating an optical waveguide device according to a second variation of the first embodiment;

FIG. 5 is a plan view illustrating an optical waveguide device according to a third variation of the first embodiment;

FIG. 6 is a plan view illustrating an optical waveguide device according to a fourth variation of the first embodiment;

FIG. is a plan view illustrating an optical waveguide device according to a fifth variation of the first embodiment; and

FIG. 8 is a sectional view illustrating an optical waveguide device according to a sixth variation of the first embodiment.

### DESCRIPTION OF EMBODIMENTS

In the following, embodiments for implementing the invention will be described with reference to the accompanying drawings. In these drawings, the same elements are referred to by the same reference numerals, and duplicate descriptions thereof may be omitted.

### First Embodiment

### [Optical Waveguide Device]

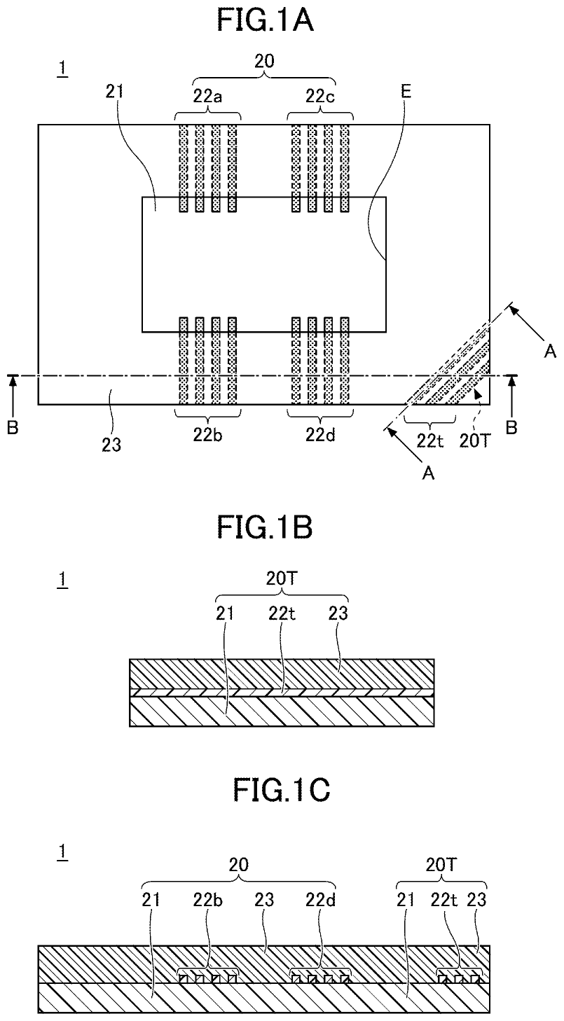

FIG. 1 is a drawing illustrating an optical waveguide device according to a first embodiment. FIG. 1A is a plan view. FIG. 1B is a cross-sectional view taken along the line A-A in FIG. 1A, and FIG. 1C is a cross-sectional view taken along the line B-B in FIG. 1A.

Referring to FIG. 1, an optical waveguide device 1 includes a first cladding layer 21, signal core groups 22a to 22d, an inspection core group 22t, and a second cladding layer 23.

The first cladding layer 21 is the lowermost layer. The thickness of the first cladding layer 21 may be, for example, about 10 μm to 30 μm. The refractive index of the first cladding layer 21 may be, for example, about 1.5. The first cladding layer 21 may be made of a photosensitive resin such as a polyimide resin, an acrylic resin, an epoxy resin, a polyolefin resin, a polynorbornene resin, or the like.

The signal core groups 22a to 22d are formed of a core layer disposed on the first cladding layer 21. In the illustrated example, each of the signal core groups 22a to 22d includes four signal cores arranged side by side at predetermined intervals. Each of the signal core groups 22a to 22d may include any number of signal cores. It suffices for the optical waveguide device 1 to include a plurality of signal core groups. For example, the optical waveguide device 1 may include a signal core group 22a including one signal core and a signal core group 22b including one signal core, and may not include signal core groups 22c and 22d.

The signal core groups 22a to 22d are cores for inputting and outputting signal light. In the signal core groups 22a to 22d, the cross-sectional shape of each signal core in the short-hand direction is, for example, rectangular. In the signal core groups 22a to 22d, the width of each signal core may be, for example, about 5 μm to 10 μm. In the signal core groups 22a to 22d, the thickness of each signal core may be, for example, about 5 μm to 10 μm. In the signal core groups 22a to 22d, the refractive index of each signal core is higher than that of the first cladding layer 21 and the second cladding layer 23, and may be, for example, about 1.6. The signal core groups 22a to 22d may be made of, for example, a material selected as appropriate from the examples listed as materials for the first cladding layer 21.

The inspection core group 22t is formed of the core layer disposed on the first cladding layer 21. In the illustrated example, the inspection core group 22t includes three inspection cores arranged side by side at predetermined intervals. The inspection core group 22t may include any number of inspection cores.

The inspection core group 22t is one or more cores for inputting and outputting inspection light. In the inspection core group 22t, the cross-sectional shape of each inspection core in the short-hand direction is, example, for rectangular. The inspection core group 22t is formed with the same specifications as the signal core groups 22a to 22d. That is, the inspection core group 22t is made of the same material as the signal core groups 22a to 22d. In addition, the cross-sectional shape of each inspection core in the inspection core group 22t in the short-hand direction is the same as the cross-sectional shape of each signal core in the signal core groups 22a to 22d in the short-hand direction. In other words, the width of each inspection core in the inspection core group 22t is the same as the width of each signal core in the signal core groups 22a to 22d. In addition, the thickness of each inspection core in the inspection core group 22t is the same as the thickness of each signal core layer in the signal core groups 22a to 22d.

The inspection core group 22t and the groups 22a are formed signal core to 22d simultaneously by photolithography using a film-shaped member. As a result, the widths of cores in these groups are regarded as being within the same range despite deviation comparable to any variation in manufacturing the photolithography method. Furthermore, the thicknesses of cores in these groups are regarded as being within the same range despite any deviation comparable to variation that the film-shaped member originally has.

The second cladding layer 23 is formed on the first cladding layer 21, and selectively covers the signal core groups 22a to 22d and the inspection core group 22t. A portion of the inspection core group 22t may optionally be exposed from the second cladding layer 23 according to need. The thickness of the second cladding layer 23 may be, for example, about 10 μm to 30 μm. The refractive index of the second cladding layer 23 may be, for example, about 1.5. The second cladding layer 23 is a cured photosensitive resin. The second cladding layer 23 may be made of, for example, a material selected as appropriate from the examples listed as the materials for the first cladding layer 21.

In the optical waveguide device 1, the first cladding layer 21, the signal core groups 22a to 22d, and the second cladding layer 23 constitute a single-mode signal optical waveguide 20. In the signal core groups 22a to 22d, each signal core may not be formed in a straight line but may include a curved portion. In the signal core groups 22a to 22d, the spacing between adjacent signal cores may or may not be constant.

In the optical waveguide device 1, the first cladding layer 21, the inspection core group 22t, and the second cladding layer 23 constitute a single-mode inspection optical waveguide 20T. In the inspection core group 22t, each inspection core may not be formed in a straight line but may include a curved portion. In the inspection core group 22t, the spacing between adjacent inspection cores may or may not be constant.

In the optical waveguide device 1, a first region E not covered by the second cladding layer 23 is provided on the first cladding layer 21. The first region E is a region where a silicon photonic chip may be mounted. One end of each core of the signal core groups 22a to 22d is arranged in the first region E. That is, one end of each core of the signal core groups 22a to 22d is exposed from the second cladding layer 23 in plan view.

In the illustrated example, one end (first end) of the cores of the signal core group 22a and one end (first end) of the cores of the signal core group 22b face each other across a gap. Further, one end (first end) of the cores of the signal core group 22c and one end (first end) of the cores of the signal core group 22d face each other across a gap. The other end (second end) of the cores of the signal core groups 22a to 22d is exposed at the outer perimeter surface (side surface) of the optical waveguide device 1. In contrast, both the first and second ends of the cores of the inspection core group 22t are exposed at the outer perimeter surface of the optical waveguide device 1.

Since the first end of the cores of the signal core groups 22a to 22d is not exposed at the outer perimeter surface of the optical waveguide device 1, it is difficult to input light and receive the output light when no silicon photonic chip is mounted. That is, without a mounted silicon photonic chip, it is difficult to perform nondestructive inspection of the signal optical waveguide 20.

In consideration of the above, the optical waveguide device 1 is configured such that the inspection optical waveguide 20T is provided separately from the signal optical waveguide 20. In the inspection optical waveguide 20T, both the ends of the inspection core group 22t are exposed at the outer perimeter surface of the optical waveguide device 1, which allows light to be easily input and output. That is, the inspection optical waveguide 20T can be inspected before mounting a silicon photonic chip. Inspection of the inspection optical waveguide 20T allows the pass or failure of the inspection core group 22t to be determined. As a result, the pass or failure of the signal core groups 22a to 22d formed with the same specifications as the inspection core group 22t can be estimated with high accuracy.

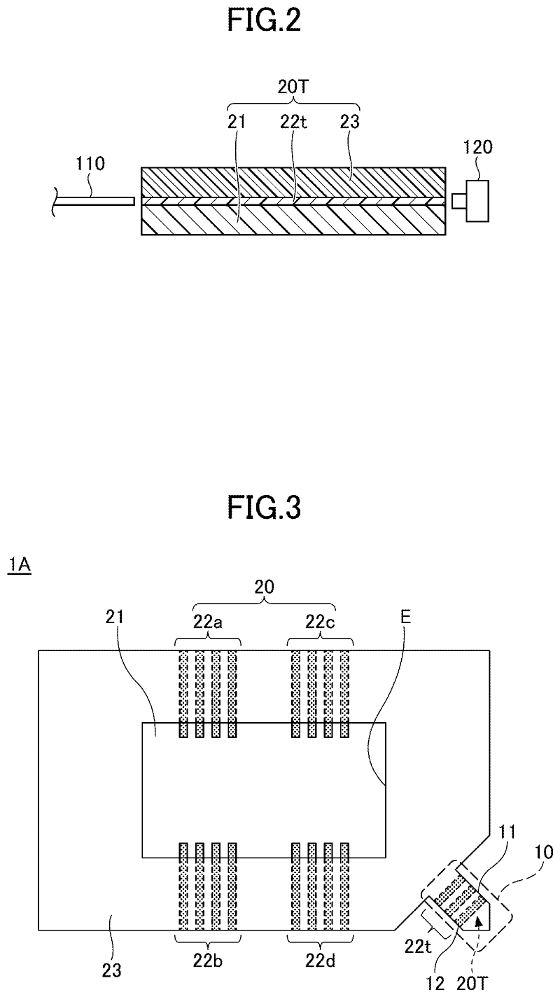

FIG. 2 is a schematic drawing illustrating a method of inspecting the inspection core group. In FIG. 2, light emitted from a light emitting unit 110 enters the first end of the cores of the inspection core group 22t, and light emitted from the second end of the cores of the inspection core group 22t is received by a light receiving unit 120. The inspection of the inspection core group 22t may be performed by converting the light received by the light receiving unit 120 into an electrical signal for analysis. The light emitting unit 110 is, for example, an optical fiber. The light receiving unit 120 is, for example, a camera capable of detecting NFP (i.e., near field pattern).

To be more specific, a check is made as to whether the light propagates in a single mode through the inspection core group 22t. Whether the core is single-mode depends on the accuracy of the formation of the inspection core group 22t, that is, whether the width and thickness of the inspection core group 22t are within the allowable error range. An inspection result indicating single-mode ensures that there is no problem with the accuracy of the formation of the inspection core group 22t. As a result, an inference can be drawn with high accuracy that there is no problem with the accuracy of the formation of the signal core groups 22a to 22d formed with the same specifications as the inspection core group 22t. The yield of the optical waveguide device 1 obtained by mounting a silicon photonic chip may thus be improved.

In order to improve the design freedom of the signal core groups 22a to 22d, the inspection core group 22t is preferably arranged near the outer perimeter of the first cladding layer 21 in plan view, and more preferably at the corners. In the optical waveguide device 1, the inspection core group 22t is arranged at the lower right corner of the first cladding layer 21 in plan view.

That is, the optical waveguide device 1 is configured such that the first cladding layer 21 has four sides in plan view, and the side where the first end of the cores of the inspection core group 22t is located in plan view differs from the sides where the second end of the cores of the signal core groups 22a to 22d is located. Further, the side where the second end of the cores of the inspection core group 22t is located in plan view is the same as the side where the second end of the cores of the signal core groups 22b and 22d is located.

In the optical waveguide device 1, the inspection core group 22t includes, in plan view, a portion that is not parallel to the signal core groups 22a to 22d. Specifically, the optical waveguide device 1 as seen in plan view is such that each core of the inspection core group 22t is linear, and is arranged at an angle of about 45 degrees relative to each core of the signal core groups 22a to 22d which is also linear. With this configuration, the inspection core group 22t is easily arranged at the corner of the second cladding layer 23 in plan view. The inspection core group 22t may alternatively be arranged at an angle other than 45 degrees relative to the linear signal core groups 22a to 22d.

### Variation of First Embodiment

Variations of the first embodiment are directed to an example in which the shape of the inspection core layer is different, an example in which a silicon photonic chip is mounted, and the like. In the description of the variations of the first embodiment, a description of the same elements as in the previously described embodiment may be omitted.

FIG. 3 is a plan view illustrating an optical waveguide device according to a first variation of the first embodiment. An optical waveguide device 1A illustrated in FIG. 3 differs from the optical waveguide device 1 in that a projection 10 is provided.

In the optical waveguide device 1A, the first cladding layer 21 has five or more sides in plan view. In plan view, the side where one end (first end) of the cores of the inspection core group 22t is located differs from the sides where the second end of the cores of the signal core groups 22a to 22d is located. Further, in plan view, the side where the other end (second end) of the cores of the inspection core group 22t is located differs from the sides where the second end of the cores of the signal core groups 22a to 22d is located.

In the optical waveguide device 1A, the inspection core group 22t is formed in the projection 10. The projection 10 in the optical waveguide device 1 having the shape illustrated in FIG. 1A may be formed, for example, by providing isosceles right triangular notches in plan view at the two sides forming the lower right corner.

The projection 10 includes a first side 11 and a second side 12 parallel to the first side 11 in plan view. In plan view, the first end of the cores of the inspection core group 22t is located on the first side 11 and the second end is located on the second side 12. In plan view, the longitudinal direction of the cores of the inspection core group 22t is perpendicular to the first side 11 and the second side 12. It should be noted that a tolerance of +5 degrees is allowed for the parallel and perpendicular alignment.

With this configuration, the cores of the inspection core group 22t at both the first and second ends thereof are perpendicular to the first side 11 and the second side 12. As a result, the first end of the cores of the inspection core group 22t can be brought closer to the light emitting unit 110 and the second end can be brought closer to the light receiving unit 120 than in the case where both the first and second ends of the inspection core group 22t are inclined to the sides of the first cladding layer 21 as in the optical waveguide device 1. The inspection core group 22t may thus be inspected easily with high accuracy.

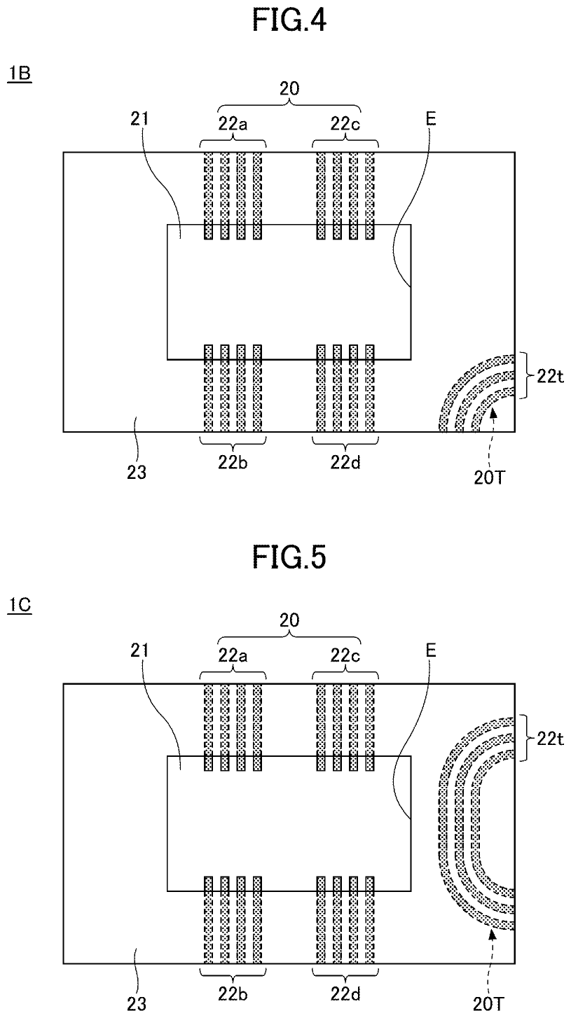

FIG. 4 is a plan view illustrating an optical waveguide device according to a second variation of the first embodiment. An optical waveguide device 1B illustrated in FIG. 4 differs from the optical waveguide device 1 in that the inspection core group 22t is curved. FIG. 5 is a plan view illustrating an optical waveguide device according to a third variation of the first embodiment. An optical waveguide device 1C illustrated in FIG. 5 differs from the optical waveguide device 1 in that the inspection core group 22t includes a curved portion and a straight portion. In the optical waveguide device 1C, the inspection core group 22t is arranged in the vicinity of an outer edge of the first cladding layer 21 rather than at a corner in plan view. As described above, the shape of the inspection core group 22t is not limited to a straight line and can be any shape.

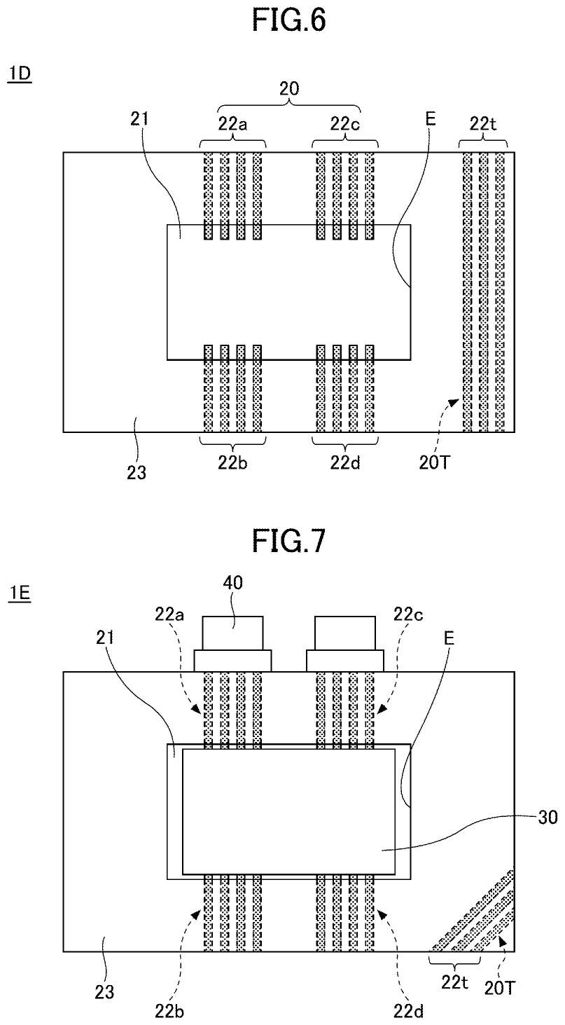

FIG. 6 is a plan view illustrating an optical waveguide device according to a fourth variation of the first embodiment. An optical waveguide device 1D illustrated in FIG. 6 differs from the optical waveguide device 1 in that the cores of the inspection core group 22t are parallel to the cores of the signal core groups 22a to 22d. In the optical waveguide device 1D, the inspection core group 22t is disposed in the vicinity of an outer edge of the first cladding layer 21 rather than at a corner of the first cladding layer in plan view. As in this configuration, the inspection core group 22t is not limited to the forms that include portions that are not parallel to the signal core groups 22a through 22d as in the optical waveguide devices 1, 1A, 1B, and 1C, but may be parallel to the signal core groups 22a through 22d.

FIG. 7 is a plan view illustrating an optical waveguide device according to a fifth variation of the first embodiment. An optical waveguide device 1E illustrated in FIG. 7 differs from the optical waveguide device 1 in that a silicon photonic chip 30 is provided. The optical waveguide device 1E includes connectors 40 connected to the signal core groups 22a to 22d at both ends of the signal optical waveguide 20, but may alternatively have no connectors 40.

The silicon photonic chip 30 includes, for example, a silicon substrate and a silicon waveguide provided on one side of the silicon substrate. The silicon waveguide is a fine optical waveguide built into a silicon chip and is used in silicon photonics technology for integrating optical circuits and the like into a silicon chip.

The thickness of the silicon substrate is, for example, about 100 μm to 800 μm. The silicon waveguide may be disposed on, for example, a protective film provided on the silicon substrate. The protective film may be formed of, for example, SiO₂ or SiOₓ. The thickness of the protective film is, for example, about 2 μm to 6 μm. The silicon waveguide may be embedded in the silicon substrate.

The silicon photonic chip 30 is disposed in the first region E with the silicon waveguide facing the first end of the cores of the signal core groups 22a to 22d, and the silicon waveguide is optically coupled to the first end of the cores of the signal core groups 22a to 22d. The silicon waveguide is adiabatically coupled to the first end of the cores of the signal core groups 22a to 22d, for example. In a case in which the silicon waveguide projects from the silicon substrate toward the first end of the cores of the signal core groups 22a to 22d, part or all of the silicon waveguide may be embedded in the signal core groups 22a to 22d. The portion of the silicon waveguide that are optically coupled to the first end of the cores of the signal core groups 22a to 22d may be tapered.

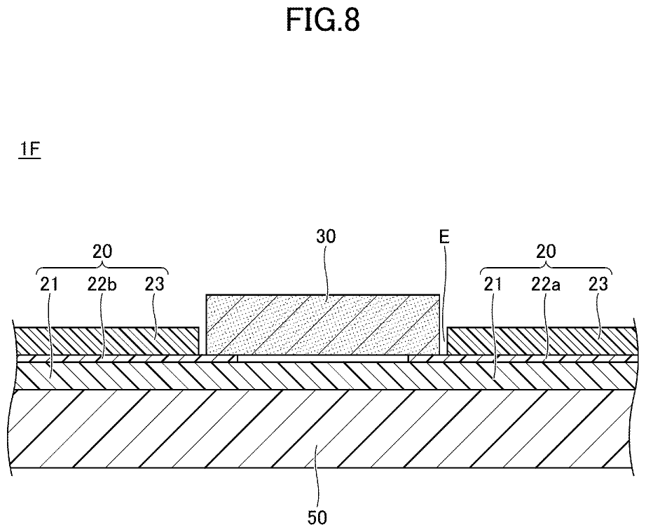

FIG. 8 is a partial sectional view illustrating an optical waveguide device according to a sixth variation of the first embodiment. An optical waveguide device 1F illustrated in FIG. 8 differs from the optical waveguide device 1E in that an interconnect substrate is provided.

In the optical waveguide device 1F, the first cladding layer 21, the signal core groups 22a to 22d, the inspection core group 22t, the second cladding layer 23, and the silicon photonic chip 30 are mounted on an interconnect substrate 50. The optical waveguide device 1F may or may not include a connector 40.

The interconnect substrate 50 is made of an insulating resin material such as epoxy resin or polyimide resin, for example. The interconnect substrate 50 may have a reinforcing member such as a glass cloth. The interconnect substrate 50 may have a structure made by laminating one or more insulating layers and one or more interconnect layers. The interconnect substrate 50 may be a rigid substrate with high rigidity or a flexible substrate with low rigidity. The interconnect substrate 50 may be, for example, a build-up substrate, a silicon substrate, a ceramic substrate, or the like.

A semiconductor chip may be mounted on the interconnect substrate 50. The semiconductor chip to be mounted is, for example, an ASIC or a logic IC. A PHY chip may also be mounted. The PHY chip is a chip that forms a physical-layer interface and may, for example, encode or decode data.

As described above, the optical waveguide device may be mounted on an interconnect substrate. This configuration serves to provide various functions. It should be noted that even an optical waveguide device which does not have a silicon photonic chip, such as the optical waveguide device 1, may suitably be mounted on an interconnect substrate.

According to at least one embodiment, an optical waveguide device is provided that allows the optical waveguide to be inspected before mounting a silicon photonic chip.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention.

Although the embodiment(s) of the present inventions have been described in detail, it should be understood that the various changes, substitutions, and alterations could be made hereto without departing from the spirit and scope of the invention.

What is claimed is:

1. An optical waveguide device comprising:
a first cladding layer;
a core layer disposed on the first cladding layer and forming a plurality of cores; and
a second cladding layer disposed on the first cladding layer and selectively covering the core layer,
wherein a first region not covered by the second cladding layer is provided on the first cladding layer,
wherein the plurality of cores include:
a plurality of signal cores, a first end of which is disposed in the first region, for inputting or outputting signal light; and
an inspection core, a first end and a second end of which are exposed at an outer perimeter surface of the optical waveguide device, for inputting or outputting inspection light, and
wherein the inspection core is made of a same material as the signal cores, and
a cross-sectional shape of the inspection core in a short-hand direction thereof is identical to a cross-sectional shape of each of the signal cores in a short-hand direction thereof.

2. The optical waveguide device as claimed in claim 1, wherein the first cladding layer has four or more sides in plan view,
wherein in the plan view, one of the sides on which at least the first end of the inspection core is located differs from one of the sides on which the second end of any of the signal cores is located.

3. The optical waveguide device as claimed in claim 2, wherein in the plan view, one of the sides where the second end of the inspection core is located is a same as one of the sides where the second end of at least some of the signal cores is located.

4. The optical waveguide device as claimed in claim 1, wherein a shape of the optical waveguide device as seen in plan view has a projection having a first side and a second side parallel to the first side,
wherein the first end of the inspection core is located on the first side and the second end thereof is located on the second side in the plan view, and
wherein a longitudinal direction of the inspection core is perpendicular to the first side and the second side in the plan view.

5. The optical waveguide device as claimed in claim 1, wherein in plan view, the inspection core is disposed at a corner of the first cladding layer.

6. The optical waveguide device as claimed in claim 1, wherein in plan view, the inspection core includes a portion that is not parallel to the signal cores.

7. The optical waveguide device as claimed in claim 1, further comprising a silicon photonic chip disposed in the first region, wherein the silicon photonic chip is optically coupled to the first end of the plurality of signal cores.
